(19) United States
(12) Patent Application Publication
(10) Pub. No.: US 2025/0367666 A1
(43) Pub. Date: Dec. 4, 2025

(54) SYSTEM AND METHOD FOR RAPID TRANSPORT, HIGH-STABILITY PARALLEL TRAPPING AND SIZE-BASED SORTING OF NANOPARTICLES ENABLED BY ELECTROHYDRODYNAMICS

(71) Applicant: Vanderbilt University, Nashville, TN (US)

(72) Inventors: Justus C. Ndukaife, Nashville, TN (US); Chuchuan Hong, Nashville, TN (US)

(21) Appl. No.: 19/225,904

(22) Filed: Jun. 2, 2025

Related U.S. Application Data
(60) Provisional application No. 63/654,533, filed on May 31, 2024.

(51) Int. Cl. B01L 3/00

(52) U.S. Cl. CPC B01L 3/502761; B01L 2200/0652; B01L 2200/0668

(57) ABSTRACT

An electrohydrodynamic tweezer device and method of separating nano-sized particles in a sample. The electrohydrodynamic tweezer device includes a first electrode, a second electrode including a gold film and an array of microholes formed therein, a fluidic chamber between the first electrode and the second electrode, and a voltage source configured to generate an electric field between the first electrode and the second electrode, wherein the array of microholes results in an array of electrohydrodynamic potentials to trap nanoscale-sized particles on the gold film.

### CROSS-REFERENCE TO RELATED APPLICATIONS

This application is a non-provisional of and claims the benefit of U.S. Provisional Patent Application No. 63/654,533, filed on May 31, 2024, the contents of which are incorporated herein by reference.

### STATEMENT REGARDING FEDERALLY SPONSORED RESEARCH OR DEVELOPMENT

This invention was made with government support under Grant Number EECS2143836, awarded by the National Science Foundation. The Government has certain rights in the invention.

### BACKGROUND

Nanoplastics originate from the decomposition of microplastics and have garnered considerable attention due to their high transmissivity from the environment into the human body, posing potential significant impacts on human health. However, knowledge of nanoplastics in the environment remains limited. Their low concentration in the ecosystem (20 g/L), as well as their nanometric size, creates substantial barriers to a comprehensive understanding of nanoplastics.

Optical tweezing and nanotweezing techniques have generated significant interest as analytical tools to study microscopic entities. These tools have exceptional precision (capable of single-particle trapping) and non-invasive manipulation. Many microplastic analyses based on optical trapping, such as Raman spectroscopy, have been successfully executed. The diffraction limit of light, however, constrains the ability of conventional optical tweezers to trap nanoscale particles with low laser power. While increasing the laser power can enhance trapping stability, high power levels can induce ‘opticusion’, meaning the explosion of trapped particles.

Plasmonic nanotweezers were consequently developed for low-power trapping of nanoscale objects. However, they face challenges in efficiently and rapidly loading particles into the plasmonic hotspot to initiate trapping. Most existing nanotweezer works rely on unpredictable Brownian motion for cavity loading. This process, governed by the diffusion limit of Brownian motion dynamics, becomes highly inefficient in low-concentration solutions. Therefore, given the low concentration of nanoplastics in the ecosystem, there is an urgent need to overcome this diffusion limitation and to expedite the loading process. Efforts have been made in this direction, with deterministic particle transport facilitated by thermally driven microfluidic flows that exploit plasmonic-heating effects, such as thermo-osmosis, thermoelectric, or electrothermoplasmonic flows. However, local heating can induce additional thermal effects, such as convections or positive thermophoresis, which can destabilize trapping.

Accordingly, a system and method that provides for a high-throughput analysis of nanoscale-sized particles that reduces or eliminates the challenges and/or disadvantages described above would be desirable.

### SUMMARY

The present disclosure provides a novel particle trapping system that leverages electrohydrodynamic (EHD) flows to transport and trap nanoscale-sized (e.g., about 1-100 nanometers in at least one dimension) particles (e.g., biological molecules, nanoplastics, and the like) with high (e.g., less than one second) trapping stability. This particle trapping system allows for the size-based separation of nanoscale-sized particles by adjusting a frequency of an applied alternating current (AC). Moreover, the integration of EHD traps with plasmonic cavities (e.g., a double nanohole aperture, a C-shaped aperture, a bowtie nanoantenna structure, or an elliptical dimmer) provides for rapid loading and trapping of single nanoscale-sized particles in less than a second without local heating effects. This system establishes a robust foundation for the high-throughput analysis of nanoscale-sized particles.

The EHD particle trapping system includes an array of microholes, and particle trapping occurs in regions between the microholes. The particle trapping is facilitated by alternating current electro-osmosis (ACEO). This system may be referred to as a concave electrohydrodynamic tweezer (CET).

In one embodiment, the present disclosure provides an electrohydrodynamic tweezer device comprising a first electrode, a second electrode including a gold film and an array of microholes formed therein, a fluidic chamber between the first electrode and the second electrode, and a voltage source configured to generate an electric field between the first electrode and the second electrode, wherein the array of microholes results in an array of electrohydrodynamic potentials to trap nanoscale-sized particles on the gold film.

In some aspects of the device, the array of electrohydrodynamic potentials enable trapping of the nanoparticles on the gold film within about 1 second.

In some aspects of the device, a frequency of the electric field is adjusted to trap the nanoparticles based on size of the nanoparticles.

In some aspects of the device, the frequency ranges from about 2 kHz to about 6 kHz.

In some aspects of the device, one of the microholes has a diameter of about 3 μm to about 100 μm.

In some aspects of the device, one of the microholes has a diameter of about 8 μm.

In some aspects of the device, a unit cell is defined between a plurality of adjacent microholes.

In some aspects of the device, the unit cell is variable in size based on size of the plurality of the adjacent microholes.

In another embodiment, the present disclosure provides an electrohydrodynamic tweezer device comprising a first electrode, a second electrode including a gold film and an array of microholes formed therein and an array of plasmonic cavities formed therein, a fluidic chamber between the first electrode and the second electrode, and a voltage source configured to generate an electric field between the first electrode and the second electrode, wherein the array of microholes results in an array of electrohydrodynamic potentials to trap nanoscale particles at the plasmonic cavities.

In some aspects of the device, the array of electrohydrodynamic potentials enable trapping of the nanoparticles within about 1 second.

In some aspects of the device, a frequency of the electric field is adjusted to trap the nanoparticles based on size of the nanoparticles.

In some aspects of the device, the frequency ranges from about 2 kHz to about 6 kHz.

In some aspects of the device, one of the microholes has a diameter of about 3 μm to about 100 μm.

In some aspects of the device, one of the microholes has a diameter of about 8 μm.

In some aspects of the device, one of the plasmonic cavities is shaped as a double nanohole aperture, a C-shaped aperture, a bowtie nanoantenna structure, or an elliptical dimmer. In some aspects of the device, one of the plasmonic cavities is circular in shape.

In some aspects of the device, the array of microholes is variable.

In some aspects of the device, a unit cell is defined between a plurality of adjacent microholes.

In some aspects of the device, the unit cell is variable in size based on size of the plurality of the adjacent microholes.

Other aspects of the disclosure will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of an example system for trapping and analyzing nanoscale-sized particles.

FIGS. 2A-2B are cross-sectional views of example nanotweezer devices.

FIG. 3A is a cross-sectional view of an example electrohydrodynamic tweezer device according to an embodiment of the present disclosure.

FIG. 3B illustrates a schematic demonstration of the electrohydrodynamic tweezer device shown in FIG. 3A.

FIG. 3C an enlarged view of a simulated micron-hole array where the color contour maps out the in-plane ACEO velocity magnitude. The strongest velocity reaches ˜300 μm/s, which enables the rapid transport of particles and high-stability trapping.

FIG. 3D is a snapshot within a field of view of 120 μm×120 μm, exhibiting capability of the electrohydrodynamic tweezer device to trap diverse sizes of polystyrene beads in parallel. The red, green, and blue circles highlight the trapped 60 nm, 100 nm, and 200 nm polystyrene beads, correspondingly.

FIG. 3E is a scattering plot of the trapped particle of various sizes. The 60 nm polystyrene beads are confined within an area of diameter smaller than 200 nm.

FIG. 3F illustrates the extracted trapping stiffness under 2 kHz.

FIG. 4 illustrates (a) the sequence of frames showing the ultra-fast loading of the electrohydrodynamic tweezer device. Right before the AC electric field was turned on (0 s), no particle was observed in the field of view. 390 ms after the AC electric field had been switched on; numerous polystyrene beads appeared in the field of view. Particles circled in blue are already settled in a trap, while other particles are still being transported. After 990 ms, all the particles were trapped. (b) the blue curve presents the simulation results of five connecting EHD potentials enabled by ACEO flow drag force on 200 nm polystyrene bead, corresponding to an array of five consecutive traps. The inset shows a snapshot picture of five traps and the 3D EHD potentials corresponding to the blue curve in (b).

FIG. 5 illustrates (a) the scatter plot of 200 nm beads positions trapped on electrohydrodynamic tweezer device pattern with various hole sizes, under 2 kHz AC frequency. The inset shows the pictures of microholes arrays within the same size as field of view. (b) the loading time measured on the three designs under 2 kHz AC frequency. The error bars indicate the standard deviation of loading time among different particles. Three μm holes have the longest loading time and 15 μm holes transport particles fastest. (c) the map of magnitude of radial DEP force exerted on 200 nm polystyrene beads. At the trapping site, DEP force is negligible.

FIG. 6 illustrates (a) the sequence of frames showing the size-based sorting. At low AC frequency, 3 kHz, all sizes of particles are trapped. When AC frequency is tuned up to 5.5 kHz, 60 nm beads are all released immediately. 100 nm beads are then released by tuning AC frequency up to 10 kHz. Finally, only 200 nm beads remain trapped. Red arrows indicate 60 nm polystyrene beads. Green arrows indicate 100 nm beads and blue circles highlight 200 nm beads. (b) the scattering plot of 200 nm bead position under varying AC frequency. Only 200 nm beads can sustain under this wide range of frequency change. (c) the extracted trapping stability along x direction of 200 nm polystyrene beads under varying AC frequency. The stability degrades dramatically as AC frequency goes up. (d) and (e) are the histogram plots along x and y direction, respectively, corresponding to the scattered plot in (b).

FIG. 7 illustrates (a) the scanning electron microscope (SEM) micrograph showing the superimposed plasmonic cavities with electrohydrodynamic tweezer microhole array. (b) the sequence of frames showing the use of the electrohydrodynamic tweezer device to rapidly transport the 60 nm polystyrene bead onto a plasmonic cavity, then use only plasmonic cavity to optically trap the 60 nm polystyrene bead, and finally release the bead by turning off the laser. (c) the scattering plot showing the positions of the trapped 60 nm polystyrene bead by either only CET or plasmonic cavity. The result indicates an enhanced trapping stability by using near-field trap with high laser power.

FIG. 8 illustrates (a) the near field distribution of a double nanohole at 973 nm laser illumination with x direction polarization. (b) is the simulated optical force on a 60 nm polystyrene bead using MST method under 15 mW laser illumination, with 1.33 μm laser spot. (c) is the trapping potential corresponding to (b). (d) is the simulated temperature rise on a sapphire substrate as the double nanohole is illuminated with 15 mW laser. The absorption cross section is also extract from full-wave simulation.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

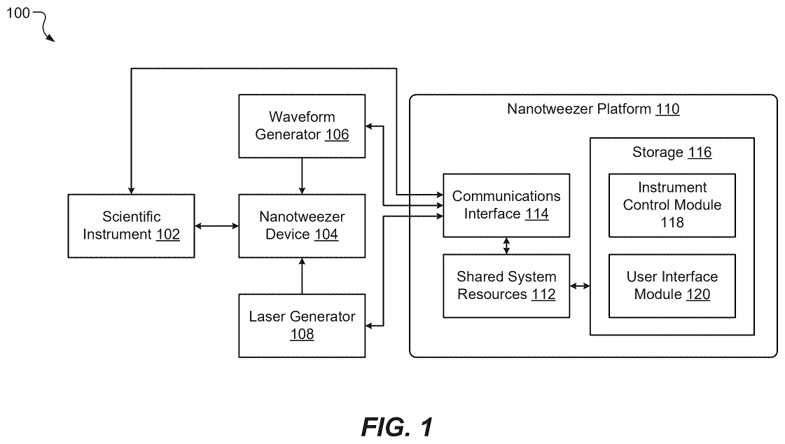

FIG. 1 is a block diagram of an example system 100 for trapping and analyzing nanoscale-sized particles (e.g., 1-100 nm in at least one dimension). As shown in FIG. 1, the system 100 can include one or more instruments for analyzing the nanoscale-sized particles, such as a scientific instrument 102, a nanotweezer device 104 for trapping and/or isolating one or more nanoscale-sized particles, a waveform generator 106 for generating electric fields at the nanotweezer device 104, and a light source such as laser generator 108 for illuminating one or more areas of the nanotweezer device 104 with one or more coherent focused light beams such as one or more lasers. The system 100 can also include one or more computing platforms, such as a nanotweezer platform 110, for controlling the scientific instrument 102, the waveform generator 106, and/or the laser generator 108.

In various implementations, the scientific instrument 102 includes one or more spectrometers, such as a mass spectrometer, a UV-visible spectrophotometer, an infrared spectrometer, a nuclear magnetic resonance spectrometer, a fluorescence spectrophotometer, a Raman spectrometer, an x-ray spectrometer, a gamma spectrometer, an electron spin resonance spectrometer, an atomic absorption spectrometer, an atomic emission spectrometer, a time-resolved spectroscopy instrument, a photoacoustic spectrometer, and/or a photothermal spectrometer.

In some embodiments, the scientific instrument 102 includes one or more microscopes. Suitable examples of microscopes include optical microscopes (such as compound microscopes, stereo microscopes, phase contrast microscopes, darkfield microscopes, confocal microscopes, and/or fluorescence microscopes), electron microscopes (such as transmission electron microscopes and/or scanning electron microscopes), scanning probe microscopes (such as atomic force microscopes and/or scanning tunneling microscopes, digital microscopes (such as digital microscopes based on optical and/or electron microscopy principles), x-ray microscopes, and/or near-field scanning optical microscopes.

In some embodiments, the waveform generator 106 produces AC and/or DC outputs. For example, the waveform generator 106 can generate one or more waveform shapes (such as, for example, sine waves, square waves, triangular waves, and/or sawtooth waves) across a range of frequencies. In some examples, the waveform generator 106 can produce AC outputs having frequencies spanning from low frequencies (for example, about 1 hertz to about 100 hertz) to high frequencies (for example, 3 gigahertz and greater). In various implementations, the waveform generator 106 can produce AC outputs having frequencies in a range of between about 2 kilohertz to about 10 kilohertz. In some embodiments, the waveform generator 106 includes a dual-channel function generator such as the Model 4047B 20 MHz Dual Channel Function/Arbitrary Generator available from B&K Precision Corporation. In some examples, the laser generator 108 can emit continuous wave and/or pulse wave laser light in the near infrared (for example, wavelengths in a range of between about 800 nanometers and about 2,500 nanometers) and/or visible (for example, wavelengths in a range of between about 380 nanometers and about 700 nanometers) spectrums. In some embodiments, the laser generator 108 includes a 973-nanometer semiconductor diode laser such as the CLD1015 laser available from Thorlabs, Inc. In some embodiments, the laser can be focused with a lens such as a 40× objective lens having a numerical aperture value of 0.75.

As shown in FIG. 1, some examples of the nanotweezer platform 110 include a shared system resources 112, a communications interface 114, and/or one or more data stores that include non-transitory computer-readable storage media, such as storage 116. In some implementations, the shared system resources 112 include one or more electronic processors, one or more graphics processing units, volatile computer memory, non-volatile computer memory, and/or one or more system buses connecting the components of the shared system resources 112, the communications interface 114, and/or the storage 116. In various implementations, the storage 116 includes one or more software modules, such as an instrument control module 118 and/or a user interface module 120. In some examples, the instrument control module 118 is configured to control the scientific instrument 102, the waveform generator 106, and/or the laser generator 108. In some embodiments, the user interface module 120 is configured to generate a user interface for users to interact with the system 100. In various implementations, the nanotweezer platform 110 is operatively coupled to and communicates with the scientific instrument 102, the waveform generator 106, and/or the laser generator 108 via the communications interface 114.

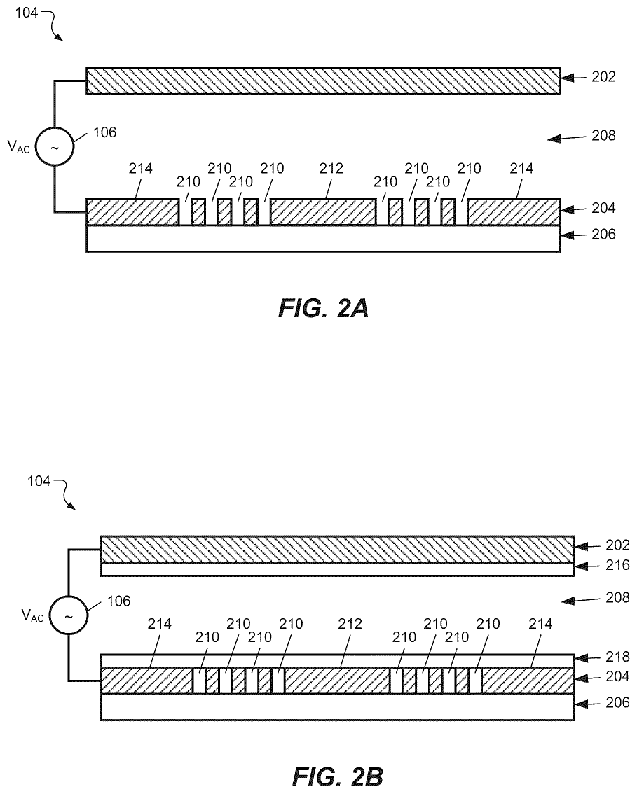

FIGS. 2A-2B are cross-sectional views of example nanotweezer devices 104. As shown in FIG. 2A, some examples of nanotweezer device 104 include a first electrode 202, a second electrode 204, and a substrate layer 206. In various implementations, the first electrode 202 can include a substantially planar structure having a thickness that is formed of a conductive material. For example, the first electrode 202 can be formed of a substantially transparent metal such as indium tin oxide. In some embodiments, the first electrode 202 can be formed of any suitable conductive materials (or a combination thereof), such as gold, platinum, silver, titanium, aluminum, tungsten, nickel titanium alloys, zirconium nitride, carbon-based materials (such as graphene and other conductive carbon films and/or carbon nanotubes), and/or conductive polymers (such as polyaniline, polypyrrole, and/or poly(3,4-ethylenedioxythiopene) polystyrene sulfonate).

In various implementations, the second electrode 204 includes a substantially planar structure having a thickness, such as a conductive film layer. In some examples, the second electrode 204 includes a conductive film layer deposited on the substrate layer 206. In various implementations, the second electrode 204 has a thickness of about 120 nm. According to some embodiments, the second electrode 204 is formed of a suitable conductive material (or a combination thereof), such as gold, platinum, silver, titanium, aluminum, tungsten, nickel titanium alloys, zirconium nitride, indium tin oxide, carbon-based materials (such as graphene and other conductive carbon films and/or carbon nanotubes), and/or conductive polymers (such as polyaniline, polypyrrole, and/or poly(3,4-ethylenedioxythiopene) polystyrene sulfonate). In some embodiments, the substrate layer 206 is formed of a glass and/or sapphire material.

As shown in FIG. 2A, the nanotweezer device 104 can include a fluidic chamber 208 defined between the first electrode 202 and the second electrode 204. Samples—such as fluids containing nanoparticles—may be introduced into the fluidic chamber 208 for trapping by the nanotweezer device 104. The second electrode 204 can include a plurality of microholes 210 arranged in a circular geometry around a central region 212. In various implementations, one or more of the microholes 210 has a diameter of about 3 μm to about 100 μm. In one example, one or more of the microholes 210 has a diameter of about 8 μm. In some examples, one or more of the microholes 210 has a depth of about 15 nanometers to about 1,000 nanometers. In one example, one or more of the microholes 210 has a depth of about 80 nanometers to about 150 nanometers. In some implementations, the second electrode 204 includes an outer region 214 surrounding the plurality of microholes 210. In various implementations, the waveform generator 106 is electrically coupled to both the first electrode 202 and the second electrode 204 and is configured to generate an electric field between the first electrode 202 and the second electrode 204.

As shown in FIG. 2B, some examples of the nanotweezer device 104 include a first cover layer 216 and/or a second cover layer 218. In various implementations, a side of the first electrode 202 facing the second electrode 204 is covered by the first cover layer 216. In some embodiments, a side of the second electrode 204 facing the first electrode 202 is covered by the second cover layer 218. In various implementations, the first cover layer 216 and/or the second cover layer 218 are formed of a dielectric material, such as glass and/or sapphire. In some examples, the first cover layer 216 and/or the second cover layer 218 are formed of an indium-tin-oxide-coated glass material spaced by a 120-micrometer thick spacer to create microfluidic channels around the patterns formed by the microholes 210. Covering the first electrode 202 and/or the second electrode 204 with dielectric layers may prevent direct electrical contact between the first electrode 202 and/or the second electrode 204 and the sample in the fluidic chamber 208.

The waveform generator 106 can generate an electric field between the first electrode 202 and the second electrode 204 in a direction perpendicular to the second electrode 204. In some embodiments, the waveform generator 106 applies an AC electric field in a direction parallel to the surface of the second electrode 204.

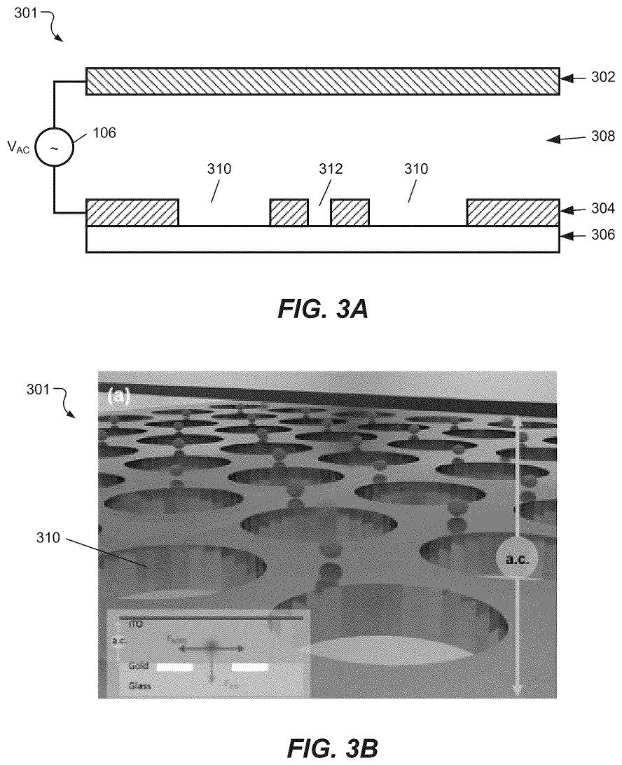

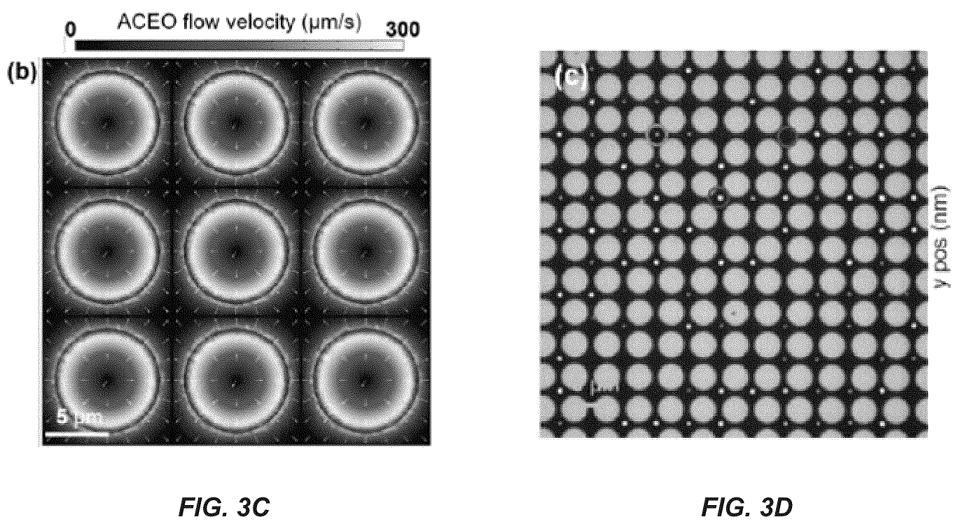

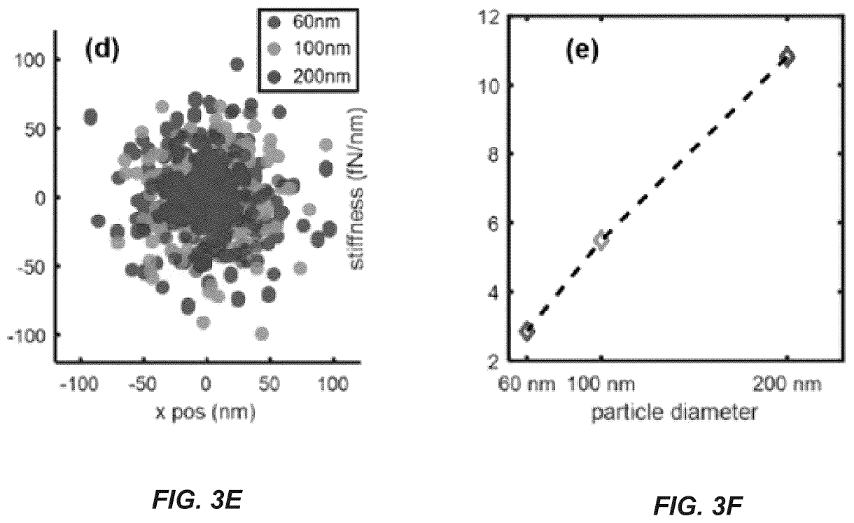

FIG. 3A illustrates an electrohydrodynamic tweezer device 301 according to some embodiments. In this embodiment, the electrohydrodynamic tweezer device 301 provides rapid electrohydrodynamic (EHD) flows to accomplish ultrafast loading (e.g., less than one second) without local heating effect. This embodiment facilitates massive parallel trapping of various nano-sized particles, achieving a high level of trapping stability beyond that of conventional optical tweezers. Additionally, this embodiment can effectively sort particles by fine-tuning an AC frequency used to apply the electric field.

As shown in FIG. 3A, some examples of the electrohydrodynamic tweezer device 301 include a first electrode 302, a second electrode 304, and a substrate layer 306. In various implementations, the first electrode 302 can include a substantially planar structure having a thickness that is formed of a conductive material. For example, the first electrode 302 can be formed of a substantially transparent metal such as indium tin oxide. In some embodiments, the first electrode 302 can be formed of any suitable conductive materials (or a combination thereof), such as gold, platinum, silver, titanium, aluminum, tungsten, nickel titanium alloys, zirconium nitride, carbon-based materials (such as graphene and other conductive carbon films and/or carbon nanotubes), and/or conductive polymers (such as polyaniline, polypyrrole, and/or poly(3,4-ethylenedioxythiopene) polystyrene sulfonate).

In various implementations, the second electrode 304 includes a substantially planar structure having a thickness, such as a conductive film layer. In some examples, the second electrode 304 includes a conductive film layer deposited on the substrate layer 306. In various implementations, the second electrode 304 has a thickness of about 120 nm. According to some embodiments, the second electrode 304 is formed of a suitable conductive material (or a combination thereof), such as gold, platinum, silver, titanium, aluminum, tungsten, nickel titanium alloys, zirconium nitride, indium tin oxide, carbon-based materials (such as graphene and other conductive carbon films and/or carbon nanotubes), and/or conductive polymers (such as polyaniline, polypyrrole, and/or poly(3,4-ethylenedioxythiopene) polystyrene sulfonate). In some embodiments, the substrate layer 306 is formed of a glass and/or sapphire material.

As shown in FIG. 3A, the electrohydrodynamic tweezer device 301 can include a fluidic chamber 308 defined between the first electrode 302 and the second electrode 304. Samples—such as fluids containing nanoparticles—can be introduced into the fluidic chamber 308 for particle trapping by the electrohydrodynamic tweezer device 301. The second electrode 304 can include a plurality of microholes 310 are arranged in a pattern, for example, as shown in FIG. 3B. The microholes 310 on the second electrode 304 may be arranged in alternative patterns and/or with alternative sized microholes that are suitable for use but not specifically shown.

In various implementations, one or more of the microholes 310 has a diameter of about 3 μm to about 100 μm. In one example, one or more of the microholes 310 has a diameter of about 8 μm. In some examples, one or more of the microholes 310 has a depth of about 15 nanometers to about 1,000 nanometers. In one example, one or more of the microholes 310 has a depth of about 80 nanometers to about 150 nanometers. In various implementations, the waveform generator 106 is electrically coupled to both the first electrode 302 and the second electrode 304 and is configured to generate an electric field between the first electrode 302 and the second electrode 304.

In various implementations, the second electrode 304 includes one or more nanoapertures 312 positioned through the conductive film layer and between the microholes 310. The nanoparticles in the sample, which is in the fluidic chamber 308, are trapped at the nanoapertures 312 as facilitated by AC electro-osmosis (ACEO). The microholes 310 perturb the local applied AC electric field and generate tangential components, which in turn, drive the ions/charges in the electrical double layer (EDL) on the conductive film layer to move laterally, creating the ACEO flow.

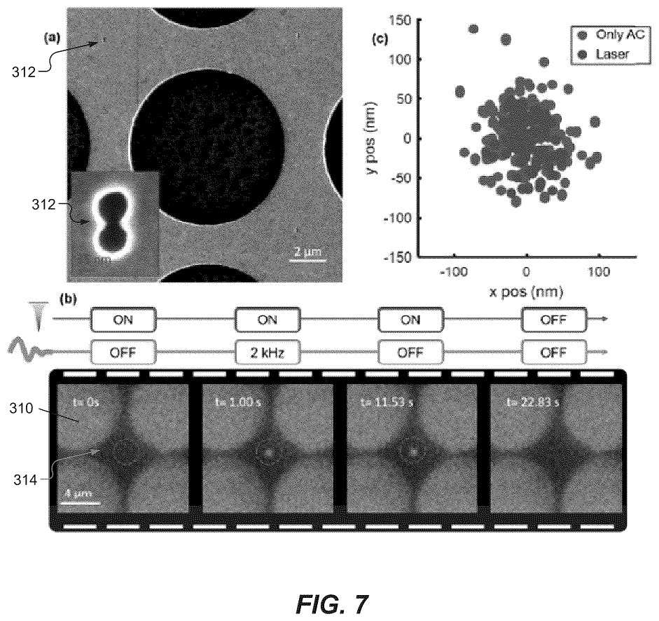

In various implementations, the second electrode 304 includes one or more unit cells 314. The unit cells 314 are positioned within or between a group of microholes 310. For example, a unit cell 314 is shown in FIG. 7 (at b) between the four microholes 310, which are adjacent to one another in the pattern of microholes 310. Additionally, FIG. 3B schematically illustrates a particle trapped at one of the unit cells 314 of the electrohydrodynamic tweezer device 301.

FIG. 3C shows the results of simulated ACEO flows, with the arrows indicating the direction of ACEO flow, pointing away from the microholes 310. The radial ACEO flows—simulated to achieve a maximum flow velocity magnitude of up to 300 μm/s—enable rapid particle transport and stable trapping. Along the out-of-plane direction, the particles are stabilized by the particle-surface interaction force, as illustrated in the inset of FIG. 3B.

Fluorescence-labeled polystyrene beads (e.g., available from Thermo Fisher Scientific) of various sizes were used with a concentration of 3×10⁷ particles/ml (50 fM). The patterned gold film was fabricated using a template strip method, and subsequently packed into a microfluidic channel with a height of 120 μm. To characterize the trapping ability of the device 301, an AC electric field of 83,333 V/m at 2 kHz was applied.

As presented in FIG. 3D, the results show that over 80% of the trapping sites are occupied by polystyrene beads. Notably, the scalable microhole array allows the number of trapping sites to be solely determined by the size of the fabricated array. Upon applying the AC electric field, hundreds, thousands, or even millions of identical EHD trapping sites were immediately generated. The experimental results confirmed successful trapping of 60 nm, 100 nm, and 200 nm beads by the device 301, with larger beads appearing brighter in FIG. 3D.

Further analysis showed that 200 nm beads demonstrated better trapping stability than 100 nm or 60 nm beads, as depicted in FIGS. 3E and 3F. This observation can be attributed to the fact that smaller particles exhibit stronger Brownian motion but encounter weaker drag force from the ACEO flows. The respective trapping stiffness values are extracted from the recorded videos using equipartition theorem and displayed in FIG. 3F. Importantly, the calculated trapping stiffness of the device 301 is consistent with previously reported stiffness values for polystyrene beads of comparable sizes. The trapping stiffness can be even further enhanced by applying a lower AC frequency. Overall, the results demonstrate the ability of the device 301 to simultaneously and stably trap multiple nanosized particles.

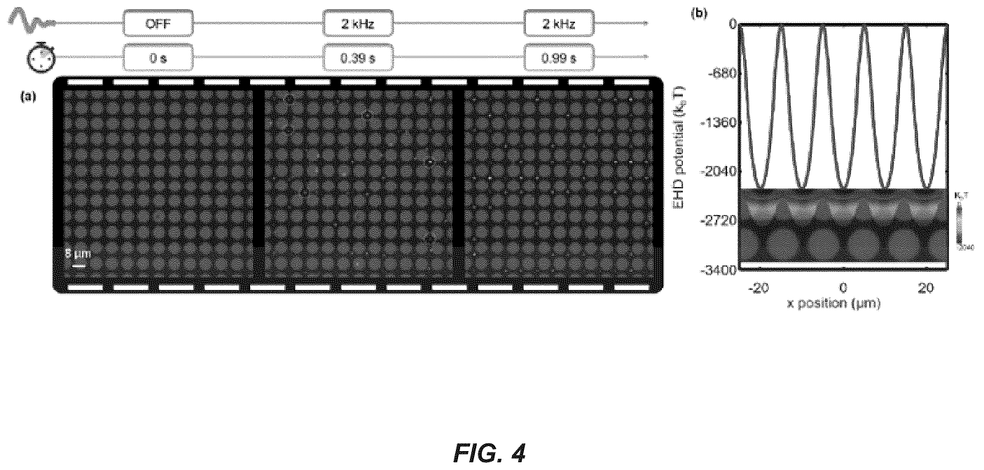

Furthermore, the device 301 features ultrafast particle loading (less than 1 second). The strong ACEO flows create rapid in-plane velocities of up to 300 μm/s, enabling swift particle delivery. This rapid loading process was captured in a video, recorded at a frame rate of 33 frames per second with a brief exposure duration of 30 ms. Consequently, the particles appear smaller in the frames of FIG. 4 (at a) than those in FIG. 3D. Several particles were loaded into traps (circled in blue) within 390 ms after initiating the AC electric field, and all particles were collected into the traps within 990 ms.

The transport and trapping mechanisms were examined by plotting an array of five consecutive simulated EHD potentials at 2 kHz on 200 nm polystyrene beads in FIG. 4 (at b). Assuming the bottom of the particle is 10 nm above the gold film, Faxen's correction was employed to calculate a more accurate EHD potential. The EHD traps were designed in an adjacent configuration to allow for the instantaneous capture of every particle above them.

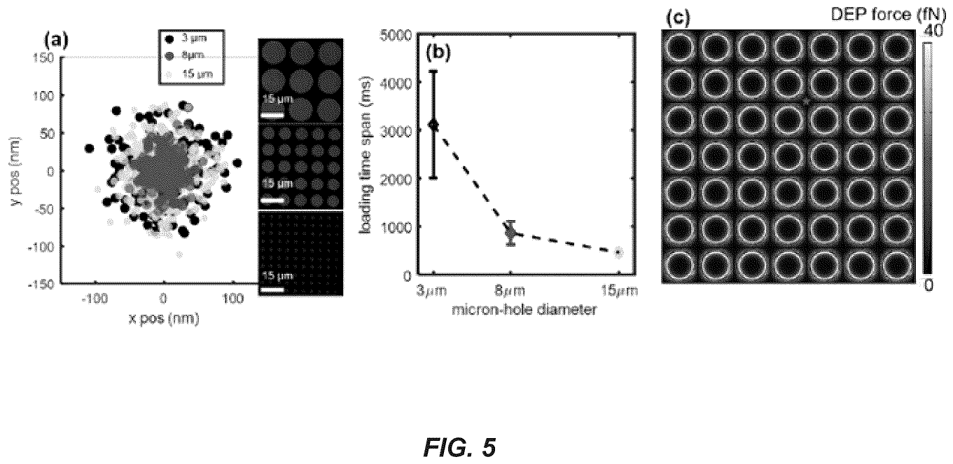

The relationship between microhole size and trapping characteristics was also explored. Three distinct designs were investigated, varying in hole sizes: 15 μm, 8 μm, and 3 μm in diameter, while maintaining the center-to-center spacing between adjacent holes constant at 2 μm larger than the diameters (17 μm, 10 μm, and 5 μm, respectively). The insets of FIG. 5 (at a) show images taken within the same field of view. The trapping stability was first examined and then the particle position scatter plots shown in FIG. 5 (at a) were analyzed, where the 8 μm holes demonstrated the highest trapping stability. The loading speed among different designs was assessed and the results summarized in FIG. 5 (at b). The 15 μm holes had the fastest loading time, followed closely by the 8 μm holes. The 3 μm holes exhibited the longest loading time and the most significant standard deviation, due to the stronger ACEO velocity produced by the 15 μm holes, as supported by FIG. 3C.

Trapping systems using micro-sized metal structures as electrodes have previously been demonstrated in the literature dependent on dielectrophoresis (DEP). However, in this study, DEP is not considered as a significant contributor to the device 301. Prior DEP trapping research studies used a different configuration for the implementation of the AC electric field, with an AC electric field amplitude ten times greater than that used in this study. Given that the magnitude of DEP is proportional to the intensity of the applied electric field, DEP is expected to make a larger contribution in their scenario. To validate, COMSOL Multiphysics was utilized to determine the magnitude of DEP on an 8 μm holes CET platform using the Clausius-Mossotti factor adopted from the literature. The in-plane DEP force magnitude map on a 200 nm polystyrene bead (FIG. 5 (at c)) showed that the DEP force at the trapping position is negligible (locations designated with a red star).

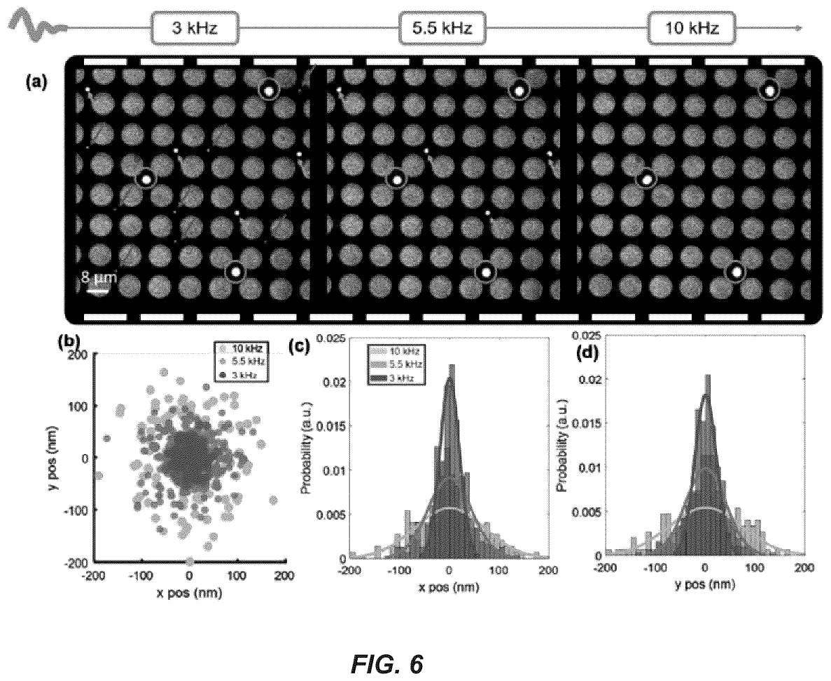

The electrohydrodynamic tweezer device 301 also provides size-based particle sorting. When the AC frequency is adjusted from low to high, smaller particles (60 nm and 100 nm) were released while larger particles (200 nm) remain trapped. FIG. 6 (at a) illustrates the frame sequence illustrating size-based sorting. All polystyrene beads of various diameters (60 nm, 100 nm, and 200 nm) were initially trapped at 3 kHz. The AC frequency was subsequently increased to 5.5 kHz, resulting in the immediate release of only the 60 nm polystyrene beads (shown by red arrows). The 5.5 kHz AC frequency was maintained to ensure that the 100 nm polystyrene beads remained trapped under these conditions. Afterwards, the AC frequency was increased to 10 kHz to release 100 nm beads. Although the trapping stability of 200 nm particles was lower than that noted at 3 kHz, it was still sufficient to retain 200 nm beads in place. Hence, by finetuning the AC frequencies in the device, size-based sorting and selective trapping of particles was successfully achieved.

Size-based sorting was investigated by examining the trapping stabilities at varying AC frequencies. As shown in the scatter plot in FIG. 6 (at b), the particle positions of 200 nm beads were tracked at various AC frequencies. The selection of 200 nm beads was made based on their consistent trapping across all tested frequencies. It was discovered that when the AC frequency increased, trapping stability decreased. Smaller particles have less trapping stability, as shown in FIGS. 3E and 3F. Consequently, as the AC frequency was elevated to 5.5 kHz (or 10 kHz), the EHD traps could not generate enough stability to trap 60 nm (or 100 nm) beads, leading to their release. Similar research has also demonstrated a decrease in trapping stability as AC frequency escalates.

The combination of a plasmonic cavity with a device 301 was assessed for speedy loading to a plasmonic cavity. The plasmonic nanotweezers, with its enhanced local field intensity, also improved the trapping stability. To counteract plasmonic heating, a sapphire substrate was used to dissipate the heat and stabilize the trapping. COMSOL Multiphysics simulations revealed successful heat mitigation by the sapphire substrate.

In the experiment, a focused ion beam (FIB) was utilized to mill a hole at the very center of the trapping site of the device 301 to create the double nanohole (DNH) aperture, as illustrated in FIG. 7 (at a). Following that, the entire trapping process was observed which included turning on an AC electric field to rapidly transport a 60 nm polystyrene bead, trapping the bead with laser illumination, and finally releasing the particle by turning off the laser and AC electric field, as shown in the frame sequence of FIG. 7 (at b). The AC electric field was turned on at 2 kHz and after ˜one second, one 60 nm polystyrene bead was loaded to the EDH potential. Subsequently, 15 mW laser was turned on, then AC electric field was switched off. The polystyrene bead remained trapped by the plasmonic cavity, and the loading only took ˜one second after turning on the AC electric field. The laser was turned off to release the particle. FIG. 7 (at c) presents a scatter plot of the positions of 60 nm polystyrene beads, trapped either solely in EHD traps or in a plasmonic cavity with 15 mW laser illumination. With this high laser power, trapping stability was improved further without the influence of heat effects. In addition, the utilization of a plasmonic cavity allowed for single particle trapping, which was useful for examining the heterogeneity of nanoplastics.

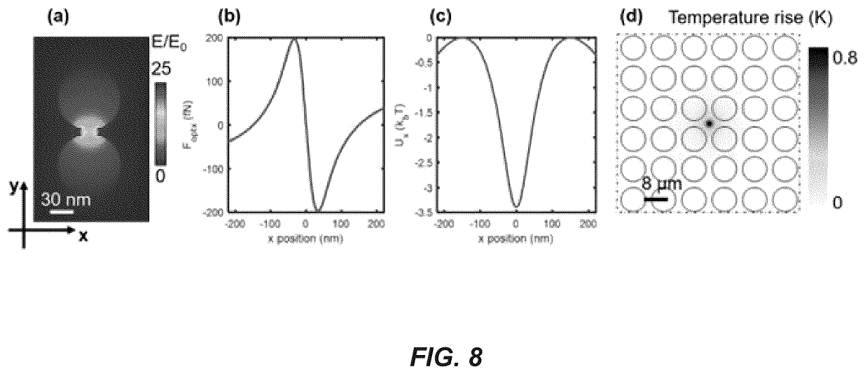

The in-plane electric field distribution at the middle of the double nanohole aperture at 973 nm illumination is shown in FIG. 8. The optical force on a 60 nm polystyrene bead (n=1.59) calculated by Maxwell's stress tensor (MST) method was provided together. The trapping potential and optical gradient force imply the stable trapping of the polystyrene beads.

The absorption cross section at 973 nm was also calculated and fed into COMSOL Multiphysics to numerically calculate the temperature distribution. The substrate is sapphire with thermal conductivity of 25.3 K/m·W, and the maximum local temperature rise was only 0.8 K, which was negligible. The thermal related effects, such as electrothermoplasmonic, positive thermophoresis or convection were subsequently diminished.

The electrohydrodynamic tweezer device 301 with a microhole array in a gold film was investigated. This device generated strong AC electro-osmosis flows, resulting in an array of electrohydrodynamic potentials that allowed for the parallel trapping of nanoscale-sized particles. Strong AC electro-osmosis flows enable ultrafast (less than 1 second) transport and high-stability trapping of particles as small as 60 nm, according to observations. In addition, size-based sorting was accomplished by adjusting the frequency of the AC electric field. Notably, the trapping stability of the device 301 was comparable to that of previously reported optical traps, and it can be seamlessly integrated with a plasmonic cavity to enhance the trapping stability and permit rapid loading into the plasmonic cavity. Consequently, the device 301 provides unrivaled opportunities for high-throughput spectroscopy of nanoplastic particles and studies of the effects of size variations.

The foregoing description is merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more steps within any given method may be executed in a different order—or steps may be executed concurrently—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

Unless the context of their usage unambiguously indicates otherwise, the articles “a,” “an,” and “the” should not be interpreted to mean “only one.” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise. Terms of degree, such as “substantially,” “about,” “approximately,” etc. are understood by those of ordinary skill to refer to reasonable ranges outside of the given value, for example, general tolerances associated with manufacturing, assembly, and use of the described aspects.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. However, the direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element.

Throughout this application, the term “module” or the term “controller” may be replaced with the term “circuit.” A “module” may refer to, be part of, or include processor hardware that executes code and memory hardware that stores code executed by the processor hardware. The term “module” may include one or more interference circuits. In various implementations, the interference circuits may implement wired or wireless interfaces that connect to or are part of communications systems. Modules may communicate with other modules using the interference circuits. In various implementations, the functionality of modules may be distributed among multiple modules that are connected via communications systems. For example, functionality may be distributed across multiple modules by a load balancing system. In various implementations, the functionality of modules may be split between multiple computing platforms connected by communications systems.

The term “code” may include software, firmware, and/or microcode, and may refer to programs, routines, functions, classes, data structures, and/or data objects. The term “memory hardware” may be a subset of the term “computer-readable medium.” The term computer-readable medium does not encompass transitory electrical or electromagnetic signals or electromagnetic signals propagating through a medium—such as on an electromagnetic carrier wave. The term “computer-readable medium” is considered tangible and non-transitory. Modules, methods, and apparatuses described in this application may be partially or fully implemented by a special-purpose computer that is created by configuring a general-purpose computer to execute one or more particular functions described in computer programs. The functional blocks, flowchart elements, and message sequence charts described above serve as software specifications that can be translated into computer programs by the routine work of a skilled technician or programmer.

It should also be understood that although certain drawings illustrate hardware and software as being located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device, or they may be distributed among different computing devices—such as computing devices interconnected by one or more networks or other communications systems.

In the claims, if an apparatus or system is claimed as including an electronic processor or other element configured in a certain manner, the claim or claimed element should be interpreted as meaning one or more electronic processors (or other element as appropriate). If the electronic processor (or other element) is described as being configured to make one or more determinations or one or execute one or more steps, the claim should be interpreted to mean that any combination of the one or more electronic processors (or any combination of the one or more other elements) may be configured to execute any combination of the one or more determinations (or one or more steps).

What is claimed is:

1. An electrohydrodynamic tweezer device comprising:
a first electrode;
a second electrode including a gold film and an array of microholes formed therein;
a fluidic chamber between the first electrode and the second electrode; and
a voltage source configured to generate an electric field between the first electrode and the second electrode, wherein the array of microholes results in an array of electrohydrodynamic potentials to trap nanoscale-sized particles on the gold film.

2. The device of claim 1, wherein the array of electrohydrodynamic potentials enable trapping of the nanoparticles on the gold film within about 1 second.

3. The device of claim 1, wherein a frequency of the electric field is adjusted to trap the nanoparticles based on size of the nanoparticles.

4. The device of claim 3, wherein the frequency ranges from about 2 kHz to about 6 kHz.

5. The device of claim 1, wherein one of the microholes has a diameter of about 3 μm to about 100 μm.

6. The device of claim 5, wherein one of the microholes has a diameter of about 8 μm.

7. The device of claim 1, wherein a unit cell is defined between a plurality of adjacent microholes.

8. The device of claim 7, wherein the unit cell is variable in size based on size of the plurality of the adjacent microholes.

9. An electrohydrodynamic tweezer device comprising:
a first electrode;
a second electrode including a gold film and an array of microholes formed therein and an array of plasmonic cavities formed therein;
a fluidic chamber between the first electrode and the second electrode; and
a voltage source configured to generate an electric field between the first electrode and the second electrode, wherein the array of microholes results in an array of electrohydrodynamic potentials to trap nanoscale particles at the plasmonic cavities.

10. The device of claim 9, wherein the array of electrohydrodynamic potentials enable trapping of the nanoparticles within about 1 second.

11. The device of claim 9, wherein a frequency of the electric field is adjusted to trap the nanoparticles based on size of the nanoparticles.

12. The device of claim 11, wherein the frequency ranges from about 2 kHz to about 6 kHz.

13. The device of claim 9, wherein one of the microholes has a diameter of about 3 μm to about 100 μm.

14. The device of claim 13, wherein one of the microholes has a diameter of about 8 μm.

15. The device of claim 9, wherein one of the plasmonic cavities is shaped as a double nanohole aperture, a C-shaped aperture, a bowtie nanoantenna structure, or an elliptical dimmer.

16. The device of claim 9, wherein one of the plasmonic cavities is circular in shape.

17. The device of claim 9, wherein the array of microholes is variable.

18. The device of claim 9, wherein a unit cell is defined between a plurality of adjacent microholes.

19. The device of claim 18, wherein the unit cell is variable in size based on size of the plurality of the adjacent microholes.
